(19) United States
(12) Patent Application Publication
(10) Pub. No.: US 2006/0277105 A1
(43) Pub. Date: Dec. 7, 2006

(54) Method for customizing multi-media advertisement for targeting specific demographics

(76) Inventor: Neil I. Harris, Burnsville, NC (US)

Correspondence Address: DAVID M. CARTER;CARTER SCHNEDLER & MONTEITH, P.A., 56 CENTRAL AVENUE, SUITE 101, P.O. BOX 2985, ASHVILLE, NC, 28802, US

(21) Appl. No.: 11/441,529

(22) Filed: May 26, 2006

Related U.S. Application Data
(60) Provisional application No. 60/687,249, filed on Jun. 2, 2005.

(51) Int. Cl. G06Q 30/00

(52) U.S. Cl. 705/14

(57) ABSTRACT

There is provided a method for customizing multi-media advertisement for targeting specific demographics by utilizing a template for a previously created advertisement. The template enables a local merchant or advertising agency to customize the advertisement with text images, voice materials or web interface for viewing by the targeted demographics.

### RELATIONSHIP TO PRIOR APPLICATION

This is a U.S. non-provisional application relating to and claiming the benefit of U.S. Provisional Patent Application Ser. No. 60/687,249, filed Jun. 2, 2005.

### BACKGROUND

Currently, in general, a multi-media advertisement is targeted to a very broad range of demographics. There is a need to be able to create advertisements which are targeted to more specific demographics by modifying previously created advertisements.

### SUMMARY OF THE INVENTION

In accordance with one form of this invention, there is provided a method for customizing multi-media advertisements by capturing a previously created advertisement in digital form and preparing a template to enable one to apply additional content to the previously created advertisement. The additional content is merged into the previously created advertisement.

In accordance with another form of this invention there is provided a method for providing customized multi-media advertisements by capturing a previously created advertisement in digital form. A desired demographic group to view the advertisement is identified. The previously created advertisement may be modified by inserting one or many templates enabling a user to add or continuously change content targeted to the appropriate for the desired demographic group. The modified advertisement is submitted to the client of the previously created advertisement for review and then the modified advertisement may be forwarded to a media distribution outlet, whereby the modified advertisement may be forwarded to a location where it will be displayed to a portion of the desired demographic group.

In accordance with yet another form of this invention there is provided a method for providing customized multi-media advertising from a previously created general purpose advertising. A desired demographic group to view the advertisement is determined. A template is created to enable one to readily modify the advertisement. The template is forwarded to a local advertising agency. Content is added to the general advertisement using the template and the modified advertisement is forwarded to the local client for review. The modified advertisement is then forwarded to a local media outlet, whereby the modified advertisement may be displayed to a portion of the desired demographic group.

### BRIEF DESCRIPTION OF THE DRAWINGS

A more complete and thorough understanding of the present embodiments and advantages thereof may be acquired by referring to the following description taken in conjunction with the accompanying drawings.

FIG. 1 is a schematic diagram illustrating certain features of the invention.

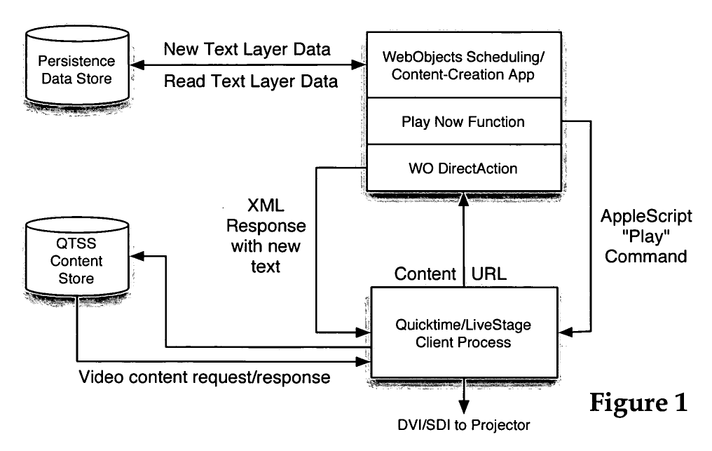

FIG. 2 is a schematic diagram illustrating other features of the invention.

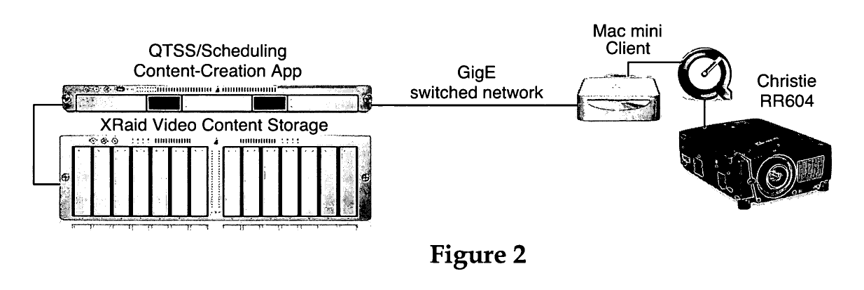

FIG. 3 is a schematic diagram illustrating additional features of the invention.

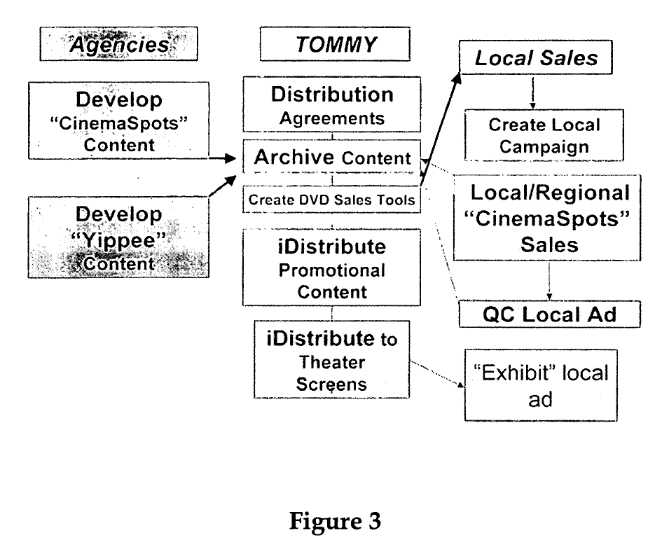

FIG. 4 is a schematic diagram illustrating further features of the invention.

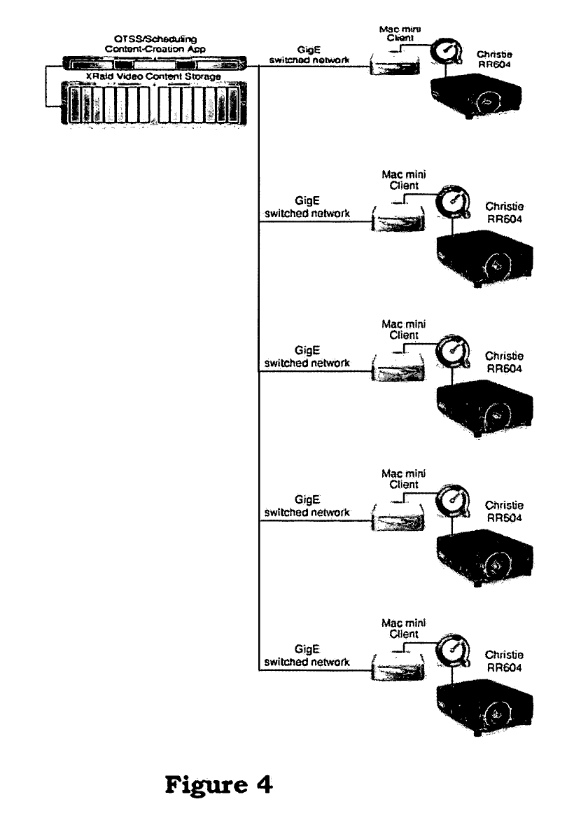

### DESCRIPTION OF THE PREFERRED EMBODIMENTS

In general and without limiting, the invention calls for the addition of a template to a previously created advertisement in digital form. The template enables a local merchant to customize the advertisement with text, images, or voice materials or live or web interface, controlled remotely from a backstage marketing environment.

This application describes specific technologies key to providing customized, pre-show, in-theater advertising. The below discussion will realize and demonstrate specific capabilities that are not common knowledge and which are crucial to such a system. The final system would be an integrated hardware and software solution requiring a more comprehensive software, hardware, networking and process development effort beyond the scope of this document. However, this application will provide forward-looking discussion on various capabilities and considerations of the target solution and will aid in understanding the general vision for the target solution.

The general goal of the system is to provide a reasonably easy to use means for local, regional or national advertisers to create and/or customize ad content targeted to specific geographies or demographics, submit the content for review and approval, and purchase specific airtime for the content in selected theaters. The primary focus of such a system is the delivery of high quality video advertising with value-added customization for local, regional or national advertisers aimed at specific demographic interests.

Advertisers, ad agencies, and other selected contributors would submit digital video content to the system along with specifications for its use and customization. This video content would in turn be made available to subscribed local, regional or national advertisers for customization allowing the advertiser to deliver targeted messaging and changeable content to specific audiences. These advertisers would use the system to supply or select base video content, create a typography overlay or add-on, review the customized video and typography product in real-time, then submit it for approval.

The system provider would then review the submission for adherence to standards and practices then either approve or reject the submission. Advertisers or their agencies would then use the system to select and purchase airtimes on various media platforms for their approved submissions.

Once airtimes have been purchased, the system would deliver the customized content to the selected media platforms for later airing. A sub-component of the system would reside within the local theaters to receive the customized content and deliver it to the selected theater screens at the appropriate times. This portion of the system would include a low cost, dynamic digital cinema delivery and control system allowing a theater owner to project the digital video ad content onto the theater screen.

This target system can be created leveraging technology available today. However the demonstration of real-time compositing of custom text, still images, voice and digital video content is key to establishing the reality of the key technology and the resulting viability of the system.

The proposed system will preferably rely on the architecture of Apple Computer, Inc's QuickTime software to provide an effective means of creating, reviewing, and approving customized ad content in real-time. Video content streams will be assigned to the video layer of a QuickTime presentation. Additional layers available through the QuickTime architecture will provide the means of delivering the “dynamic” text and graphics. The resulting content can then be delivered via secure internet connections over residential fast access means. As such, the ad customization and purchasing capabilities can be delivered to local advertisers working in their own homes, as commercial grade connectivity would not be necessary.

Two alternatives exist for delivering the completed content to the theater screens. One alternative is to continue the use of the QuickTime architecture and thus provide the capability to deliver additional overlays, crawlers, or messages with real-time data feeds (e.g., stock indices, sports scores, weather bulletins, etc.). The use of QuickTime as the delivery medium might include the use of Apple's Mac mini as a Set Top Box (STB) as the client machine in the projection room. Client nodes must be devices capable of launching a QuickTime player equipped with a TOMMY designed and detailed template (TT).

The second alternative for delivering content to the theater screen would use standard MPEG display technologies. This would permit the use of standard Set Top Box components as the projection room clients and would leverage a more common standard (MPEG) for the video content. However, this alternative would require all content to be created, composited, and MPEG encoded well in advance of airtime.

The QuickTime architecture alternative is preferred as the projection client as it is a component of the ad customization and review process and its application as a projection room client is less obvious than the use of standard MPEG-based technologies.

For the purposes of establishing a common language for the system, one should first provide a broad description of the components of the completed target system. The target system would be comprised of several software applications, integration and control capabilities, and hardware entities that work together to realize the goals of the system.

Listed below are some definitions applicable to this system.

“Contributor” is a secure, web-accessible capability allowing ad agencies, corporations, and other content creators to submit video content that will serve as the base for theater ad spots. The Contributor application will be housed on a server in a central operations location.

“Customizer” is a secure web-accessed capability allowing local commerce and resellers to create ad spots with their own, customized messaging added in provided places in the video content. The Customizer application will be housed on a server in a central operations location.

“Approver” is a secure, web-based capability allowing standards and practices as well as national advertisers to review and either approve or reject customized as spot submissions. The Approver application will be housed on a server in a central operations location.

“Scheduler” is a secure capability that realizes the request/grant circle for ad time allowing the specification of location, theater, show, and time slot. The Contributor application will be housed on a server in a central operations location. The Scheduler application will be housed on a server in a central operations location.

“Distributor” is a client/server capability that delivers approved content to local multiplexes for local storage and later projection. Distributor is an automated capability driven by Scheduler and housed within a central operations center.

“Director” is a client/server capability that receives completed content from Distributor and scheduling data from Scheduler. It stores the content on local storage and later streams the completed, approved, custom content to the theater projection points according to the scheduling data from Scheduler. Director is housed on a server within each multiplex.

“Player” is a client capability that receives content from Director and delivers it to the projection system. A Player is housed in each projection room and is connected to that theater's digital projection system.

“Central Operations” is the brick-and-mortar, IT center for the target system. This will likely begin as a single facility, but may eventually scale to multiple geographic centers.

“Multiplex” is the individual, local multiplex that subscribes to the system.

“Theater” is an individual theater within a multiplex.

“Virtual Clients” (Contributor, Customizer, Approver are client workstations using secure web connections to the Central Operations center to access the system.)

In addition to the software functional components, functional facilities, and logistics and procedures build-out defined or alluded to above, the following items are also of importance.

An authentication component would be useful, which would differentiate between registered advertisers and staff. Advertisers who had registered could buy space, schedule spots, select background video from a library, select a TT template from a template library, and add any specific text, photography, videos or voice they wish to composite over their video content. Custom video content would have to be sent in and installed by staff, due to the large file size of video content. Traditional content and national content could also be installed by staff, and scheduled by staff as well.

In the case where STBs are used as client decoding devices in the projection room, a Mac mini (STB) would be used as the Director component. Content creation in that system would not be an automated process, since asynchronous compositing would be required once the content components had been assembled. In such a system, a staff member would use Apple Pro Tools to compile and composite the content once the local advertiser content components (video, text, etc.) had been approved. Once created, the content could be stored on the Xserve RAID device and the STB could be accessed to set up scheduling.

If near-real-time text compositing is required (and independent of whether hardware decoding is required), then a custom scheduling and content creation component must be created. Text layer data would be saved in a persistence store, (database perhaps) and keyed to a particular content stream. A content stream would be defined as the content to be streamed to a particular projection room at a particular time. Meta-data for a stream would include its content key pointing to a particular video background and text data stored in the database, as well as schedule information.

Components mentioned in the above summaries include but may not be limited to: Authentication Component; Advertiser Registration Component; Spot Creation, Editing and Scheduling Component; E-Commerce Style Payment Component; Stream Execution Component; and Staff Interlace Component.

A combined Director/Player application will be used. In production, video streams will originate from a QuickTime Streaming Server within the multiplex controlled by the Director application. These streams will be transmitted to the Player workstations in the projection rooms over a secure, local, high-speed network. The Director and Player applications may be realized as a single application on a single laptop for demonstration purposes. In production, a more sophisticated custom scheduling application would be used for playback. To show viability however, a “Play Now” capability will suffice.

In a simplified form, Director will also allow the user to “select” the video stream content, even though there will be only one choice. Once the background video has been selected, the user will be presented with a means to add a text layer to the presentation. In the full production system, this capability would be largely realized within the Customizer. Once the customized data has been saved, subsequent “Play Now” executions will display the new text layer onscreen. In the full production system, this play functionality would be handled by the Player workstation attached to a digital projector.

The Director application user interface will be designed with a “wizard-like,” serial workflow in mind, much the same as an e-commerce application. To show viability, this interface will remain rather simple. In production, more sophisticated e-commerce features can be added and the functionality would be divided among the software components described above.

The Player workstations will run a QuickTime Player in full screen mode. The content will be designed using TT. The TT application will allow for the creation of complex templates. In this context, a template means a blank canvas, defining what items can be dynamic, what can be determined at runtime, etc. The TT template will allow for a background video stream and one text layer, the content of which shall be provided at runtime. This is achieved by reading the text from a persistence store once the WebObjects application has finished writing it.

The Player workstations in this system will be designed simply to retrieve and play content from a specific master URL. This URL will actually invoke a direct action URL for the Director application. Certain necessary meta-data can be passed into the direct action if necessary, by sending them first to the Player and then designing the TT script to parse them and pass them along into the direct action call. The Director application will then return XML data expected by the TT template, which will use that data to obtain a handle to the video content and composite the additional material (text layers).

This discussion of hardware shall consist of three sections. The first section represents the hardware configuration we will design to and rely on for the actual proof of concept demonstration. The second and third sections will describe a proposed production configuration for the initial rollout, and a theoretical upper-end configuration describing a potential migration path, respectively.

The configuration required to satisfy the viability demonstration is minimal. The platform will be a PowerBook G4 supplied by the customer. A single content video file will be loaded onto the machine, and instead of actually using a QuickTime Streaming Server, we will identify the content locally (i.e., using a local file system path). A rudimentary and significantly limited Director-like application will be implemented to facilitate rapid delivery.

A customer-supplied platform will be configured on a Mac OSX Server. An application will be supplied that will provide the Director control interface for the proof of concept demo. This interface will include controls for video file selection, text entry for the desired text overlay, and a “Play Now” button. The demo will consist of starting the application, selecting a content stream (there will be only one,) typing in the desired text for the overlay, and pressing the “Play Now” button. This will cause an AppleScript process to execute, which will modify the supplied template XML with the desired text and then cause the local QuickTime Player to launch in full screen mode to display the desired QuickTime movie with the injected text overlay. During the demonstration, it will be up to the demonstrator to explain that the projection nodes in production will not be required to do this administrative double duty, but that in fact the production application will be more sophisticated and will be accessible by theater staffers on the network.

For demonstrations, a conference room with an available low-end portable or fixed-installation projector will suffice. If a projector is available, it will be used either through an available DVI input or a simple S-Video input. Audio will be delivered with standard built-in speakers or small, computer speakers with a Mini interface. If no projector is available, the demonstration may also be presented on the LCD screen of the client/server machine.

Once the selected stream has played, the demonstrator will press Cmd-Q to quit the QuickTime Player. The browser will present and the demonstrator will proceed to the detail page of the stream. Here we will see that the stream consists of a video content file and a textual message. The content file will be in a selectable widget. However, there will be only once choice. The textual message will appear as it did onscreen. The demonstrator will alter the textual content and press “Save.” Then the demonstrator will return to the main page and press “Play Now” again to display the video stream with the new text.

The production environment would differ substantially from the simplified configuration described above in several ways. First, the Director application would be developed and deployed as a WebObjects application hosted on an Xserve, with an Xserve Raid device attached to it for QTSS content storage. This Xserve would also run the QuickTime Streaming Server itself, and would respond to the TT calls for background content. Theater administrators and local advertisers would access the application server via a web browser on the network, and new content could be scheduled and component parts uploaded per defined approval and standards processes using the other software components of the system.

The projection room would contain a Mac mini running QuickTime, with the TT template loaded. The scheduling part of the application server would generate the necessary commands to start the various client playback routines. The Mac mini would connect via the DVI interface to a Christie RoadRunner L6 series projector, which would provide XGA resolution.

A Mac mini will be used as a Player client device to establish initial capability at a reduced cost. This would allow the full use of the QuickTime player, and would provide a DVI interface to the Christie, at a very low cost.

A discussion about migration must include a forward-looking scenario in which the delivery and display of high-resolution content is possible. Such a scenario would normally use projectors in the projection room that are capable of delivering 1080i and 1080p resolutions. In this case, a migration of this system would require that the projector in each projection room be replaced at a minimum, since the RoadRunner won't display the higher resolutions. The cost of a projector capable of displaying 1080p/24 (‘2K”) content is an order of magnitude greater than that of the RoadRunner. There is a significant gap in the capabilities of the current lines of projection equipment. However, in the future the cost of projecting 1080p/24 content could fall.

If only a migration to 720i were desired, a projector in the $50K range would suffice. This resolution would not require a SDI interface between the client and projector. A G5 with a Decklink card would in this case be overkill, unless hardware decoding of MPEG-2 and almost-real-time compositing were both absolutely non-negotiable requirements.

If hardware MPEG-2 decoding were a priority over near-real-time text layer compositing, then a Tivella STB would be the best client solution. If near-real-time text layer compositing were the priority however, a STB would not be viable. In this case, a Mac mini might suffice (depending upon the video capability of the Mac mini). The best hardware architecture for the production system can be detailed further once the final requirements for subsequent phases are decided.

The technology oriented multi-media system (TOMMY) may operate as set forth below.

TOMMY collects promotional videos from Advertising Agencies after licensed TOMMY templates are inserted into the promotional videos by each Advertising Agency. The TOMMY templates include information which designates (a) the demographic appeal code(s); (b) the SIC code(s); (c) the source, i.e., agency, advertiser, production house, and/or contact information; and (d) the date received.

TOMMY collects movie lists from Studios, i.e., movies designated for future release. The lists are sorted by (a) MPAA (Motion Picture Association of America) rating if available; (b) the demographic appeal code(s); (c) the release date and “flight” designation #1 through #13 (4 weeks equals one flight); (d) the critic rating number (5 levels),); (e) an “other” category; and (f) theatres. The theatres are also sorted by zip code, address, screens carrying movies, and demographic profile(s) of nearby communities. The screens are further sorted by the technology at each movie screen, i.e., full digital, DVD player, or analog projector. The demographic profile(s) of nearby communities are further sorted by Claritas data types, for example and for other source services.

TOMMY creates a “local” template for each local advertiser/“no national connection.” The templates are sorted by (a) SIC code; (b) design elements or designer/creative source/agency; (c) creation date and amendment date; and (d) “last time utilized.”

TOMMY prepares a DVD sample package for sales executives. To create the sample package TOMMY creates movie listings sorted by release date. Each movie listing includes a “Flight” designation/release date of #1 through #13, the MPAA rating, the demographic appeal code and the critic rating number (5 levels). TOMMY then merges the promotional videos based on the SIC code, the demographic appeal code and the MPAA rating. The next step in creating the sample package merges the movie lists and completed video with the pre-inserted template based on the SIC code (for “Here's the video to carry your “deal”, here are your choices:”), the Flight designation/release date, the demographic appeal code and the MPAA rating. A digital file is created for DVD burn. Prior to burning, the digital file is checked for completeness. Mailing lists are pulled up and the numbers of samples are checked for completeness. If the samples are complete, the file is sent to a DVD burner or to vendor for DVD burning. The quantities of DVDs to be burned and packaged are determined utilizing the mailing list. The DVD samples are then mailed out to sales executives. If the digital file is not complete, it is returned to the approval manager and notification procedures are implemented.

TOMMY sales executives visit local and regional customers after determining the advertising requirements for each visit or contact. The sample videos to be presented are chosen based on the SIC code of the customer's business, the demographic profile of that business' desired customer, the MPAA ratings and the Flight number. Also, in order to identify the movies that best carry the product/service relationship, the sales executive may use previous conversations and customer trends. The sales executive sorts the sample videos by pre-determined assembly prior to the customer visit. The sales executive downloads the sample videos on to a laptop and presents the sample videos to the customer.

The advertiser selects from TOMMY's sample DVD and manual form. The customer fills out the form with the sales executive and is e-mailed a “password” for two uses by account name. The customer selects and checks the movie name, the screen(s), and the Flight number by movie name, video name, DMA, zip code, town, city, state or country, multi-plex and by circuit. The customer also selects an ad design for their promotion. Verbiage is inserted into the sample web site template by the sales executive, with the customer, to demonstrate the ease of change. (Demo program utilized on DVD.) The customer data is inserted into the TOMMY web site by the sales executive after the meeting.

The cost is based on the selection of screens and the technology utilized. For example, full digital would equal a pre-determined amount. The method of payment may be by deposit, credit card, terms or as agreed by contract at the time of the visit.

A report is generated at TOMMY at the cut off date for each “flight.” The report is sorted by the circuit owner, by screen, by video, by customer name, by Flight number, by movie and by multi-plex.

The advertiser's product is assembled by output count and entered into digital files for internet delivery.

TOMMY assembles the final advertising, collects the media destination, ie., movie name, adds the multi-plex, screen and the pre-edited video sequence with the customer's ad choice and initial verbiage. TOMMY creates the final screen assembly based on the product type. For example, in the case of full digital, the video ad choices are first sent by the advertiser to TOMMY via the internet. The verbiage inserts/choices are sent by TOMMY prior to the Flight to each screen.

On-going customer data management and output is repeated each “Flight.” A four week period equals one Flight. A customer who selects full digital may log on to the TOMMY web portal and change the verbiage (“deal”) on demand. Logging on to the portal involves filling in the account name and password. The customer's current account history is presented, including the movie, theatre, and the location, technology, billing status, promotional video code and flash code for the contracted screen(s).

The template verbiage, screen, and location may be changed via the internet immediately upon pressing “Send.” The change(s) will be intercepted by the Standards and Practices Team who will approve or reject the change. If the change is accepted, it will be sent through to the destination. If the change is rejected, the customer will immediately receive notification by e-mail and by a telephone call to the customer's designated cell phone(s) of the rejection.

The process for loading the advertisement into a full digital system at each theatre location includes TOMMY connecting to the Circuit Owner system over the internet and upon receiving approval from the Circuit Owner system, the initial screen loading begins. The initial sequenced videos and their initial customer designated template information is downloaded to the main server and then to each particular screen's set-top box. The initial “deal” verbiage is sent to the specific video on each screen contracted by customer. Prior to the first “exhibition” of the movie, the theatre address, screen, movie and projector address are confirmed. TOMMY queries the system to confirm that the proper arrangements are in place. Upon confirmation, any new “text” verbiage is released to the specific screen's server and then to designated set-top box.

While the invention has been described in terms of the above embodiments, those skilled in the art will recognize that the invention can be practiced with modification within the spirit and scope of the appended claims.

1. A method for customizing a multi-media advertisement comprising:
capturing a previously created advertisement in digital form;
preparing a template to enable one to apply additional content to the previously created advertisement; and
merging the additional content with the previously created advertisement.

2. A method for providing a customized multi-media advertisement comprising:
capturing a previously created advertisement in digital form;
determining a desired demographic group to view the advertisement;
modifying the advertisement by additional content to the advertisement appropriate for the desired demographic group;
submitting the modified advertisement for review and approval; and
forwarding the modified advertisement to a media outlet, whereby the modified advertisement may be displayed to a portion of the desired demographic group.

3. A method for providing a customized multi-media advertisement comprising:
obtaining a previously created general purpose advertisement;
determining a desired demographic group to view the advertisement;
creating a template to enable one to readily modify the advertisement;
forwarding the template to a local advertiser or advertising agency;
adding content to the general advertisement using the template;
forwarding the modified advertisement to a local client for review; and
forwarding the modified advertisement to a local media outlet, whereby the modified advertisement may be displayed to a portion of the desired demographic group.
